(19) United States
(12) Patent Application Publication
(10) Pub. No.: US 2004/0095742 A1
(43) Pub. Date: May 20, 2004

(54) Plane lighting structure

(75) Inventors: Che-Kuei Mai, Hsinchu (TW); Ching-Huang Lin, Ma-Gong City (TW)

Correspondence Address: LOWE HAUPTMAN GOPSTEIN GILMAN & BERNER, LLP, Suite 310, 1700 Diagonal Road, Alexandria, VA, 22314, US

(73) Assignee: Toppoly Optoelectronics

(21) Appl. No.: 10/298,575

(22) Filed: Nov. 19, 2002

(51) Int. Cl. F21V 7/04

(52) U.S. Cl. 362/31; 362/27; 362/330

(57) ABSTRACT

A plane lighting structure includes a light source and a wedge light guide plate having a light-transmissive surface that can guide the light rays emitted from the light source toward the direction which is about perpendicular to the connecting line from the light source to the wedge light guide plate, wherein the wedge light guide plate has two different materials and the light-transmissive surface is located between the two different materials.

### BACKGROUND OF THE INVENTION

1. Field of the Invention

The present invention generally relates to a plane lighting structure, and more particularly to a plane lighting structure having a wedge light guide plate with two different light refractive index materials.

2. Description of the Prior Art

Many display devices need the plane light sources such as LCD monitors and scanners. It is well known to use an incandescent lamp or LED as a point light source or a cold cathode fluorescent lamp (CCFL) as a line light source. There are two direct methods to form the plane light source, one is to assemble an array of the above-mentioned point light source, and the other is to assemble a row of the above-mentioned line light source. However, such methods will not only waste the power supply, but also be detrimental to the cost reduction.

It is advantage to form the plane light source by using the light guide plate such as the wedge plate 10 shown in FIG. 1A or the flat plate 20 shown in FIG. 1B. These light guide plates can guide the light rays emitted from the light sources 12,22 toward the liquid crystal cell array (not shown in these figures) through the reflecting slant portions (V-cut) or the convex/concave dots. Presently, there are many improvements on the wedge light guide plate 10 in FIG. 1A, such as U.S. patent publication No. 20020005991, which enhances the uniformity by putting a prism sheet above the light guide plate to avoid the light rays emitted directly into the eyes of user from the light source.

However, there are still some drawbacks in above two methods for forming the plane light source. First, as shown in the wedge plate 10 in FIG. 1A, the brightness of the light source 12 is usually focused on the position that is about one-third length of the light guide plate close to the light source 12. It causes the unbalanced light uniformity for the left and right sides of the wedge light guide plate 10. Besides, as shown in FIG. 1B, to use the flat guide plate 20 with the two light sources 22 can decrease the above-mentioned problem but the brightness at the midst of the flat guide plate 20 is darkest.

Another method for resolving the light uniformity as shown in FIG. 2, provided by Fujitsu, is to use the hollow structure of the light guide plate. The light rays are emitted from the light sources 30 at the both lateral sides of the light guide plate into the panel of the LCD monitor through the lens 32, two pieces of the lens 34 with the specified reflection index, two pieces of the control sheets 36 with the specified refraction index, and the lens set 38. Besides, two reflection sheets 40 can be affixed on the bottom of two pieces of the lens 34 in order to increase the brightness. However, this complex plane lighting structure not only increases the cost and the difficulty of the production, but also reduces the yield of the production.

### SUMMARY OF THE INVENTION

In the light of the state of the art described above, it is an object of the present invention to provide a light guide plate with two different materials which is immune to the problems of the conventional plane lighting structure described above and which can increase the brightness of the plane lighting structure because the energy loss of the light rays is reduced in the light guide plate.

It is also an object of this invention to extend the lift life cycle of the plane lighting structure.

It is an another object of this invention to provide a hollow wedge light guide plate for reducing the energy loss of the light rays to increase the brightness of the plane lighting structure.

It is a further object of this invention to decrease the weight of the plane lighting structure.

In view of the above and other objects which will become apparent as the description proceeds, there is provided according to a general aspect of the present invention a plane lighting structure which includes a light source; and a wedge light guide plate having a light-transmissive surface that can guide the light rays emitted from the light source toward the direction which is about perpendicular to the connecting line from the light source to the wedge light guide plate, wherein the wedge light guide plate has two different materials and the light-transmissive surface is located between the two different materials.

Base on the idea described above, wherein the light-transmissive surface has a plurality of reflecting slant portions.

Base on the aforementioned idea, wherein light refractive index of one of two different materials is about 1.

Base on the idea described above, the wedge light guide plate further comprises a reflection surface affixed on the light-transmissive surface to increase the brightness.

Base on the aforementioned idea, wherein the light rays emitted from the light source pass through one of two different materials in the wedge light guide plate.

Base on the idea described above, the wedge light guide plate further comprises a reflection layer placed below the bottom of the light guide plate to increase the brightness.

Base on the aforementioned idea, the wedge light guide plate further comprises a plurality of convex and/or concave dots set between the reflection layer and the wedge light guide plate.

Base on the idea described above, wherein the light source is selected from the group consisting of the cold cathode fluorescent lamp (CCFL) and LED.

There is provided according to a general aspect of the present invention a plane lighting structure which includes a light source; and a light guide plate having a light-transmissive surface that can guide the light rays emitted from the light source toward the direction which is about perpendicular to the connecting line from the light source to the light guide plate. The light guide plate further comprises a first material; and a second material which surrounds the first material, wherein the light-transmissive surface is located between the first and second materials and the light rays pass mainly through the first material.

There is provided according to a general aspect of the present invention a plane lighting structure which includes a light source; and a light guide plate having a light-transmissive surface that can guide the light rays emitted from the light source toward the direction which is about perpendicular to the connecting line from the light source to the light guide plate, wherein the light rays pass through the air except the light-transmissive surface in the light guide plate.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A illustrates a conventional plane lighting structure with the wedge light guide plate;

FIG. 1B illustrates a conventional plane lighting structure with the plat light guide plate;

FIG. 2 illustrates a conventional plane lighting structure with the hollow light guide plate provided by Fujitsu;

FIG. 3 illustrates the first preferred embodiment of the hollow wedge light guide plate according to the present invention;

FIG. 4 illustrates the second preferred embodiment of the hollow wedge light guide plate according to the present invention;

FIG. 5 illustrates the third preferred embodiment of the hollow wedge light guide plate according to the present invention;

FIG. 6 illustrates the fourth preferred embodiment of the hollow wedge light guide plate according to the present invention, wherein the substance of the light guide plate beside the light source is removed; and

FIG. 7 illustrates the fifth preferred embodiment of the hollow wedge light guide plate according to the present invention, wherein the substance of the light guide plate beside the light source is replaced with a diffusion prism sheet.

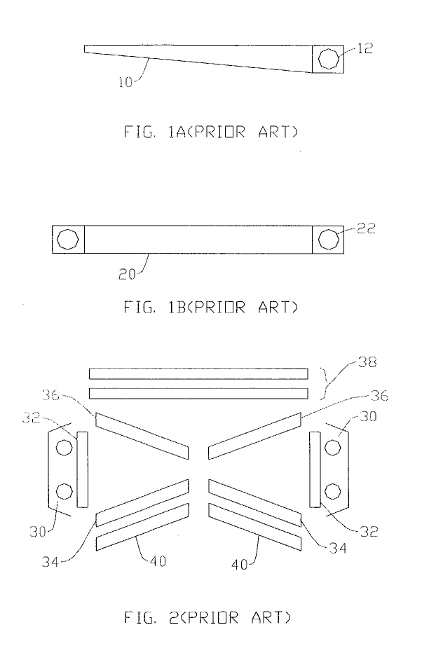

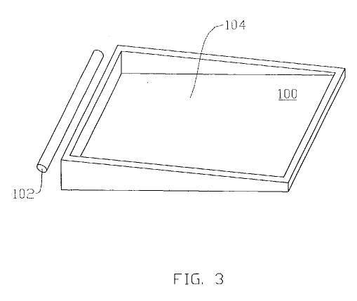

### DESCRIPTION OF THE PREFERRED EMBODIMENT

Some sample embodiments of the present invention will now be described in greater detail. Nevertheless, it should be recognized that the present invention can be practiced in a wide range of other embodiments besides those explicitly described, and the scope of the present invention is expressly not limited except as specified in the accompanying claims.

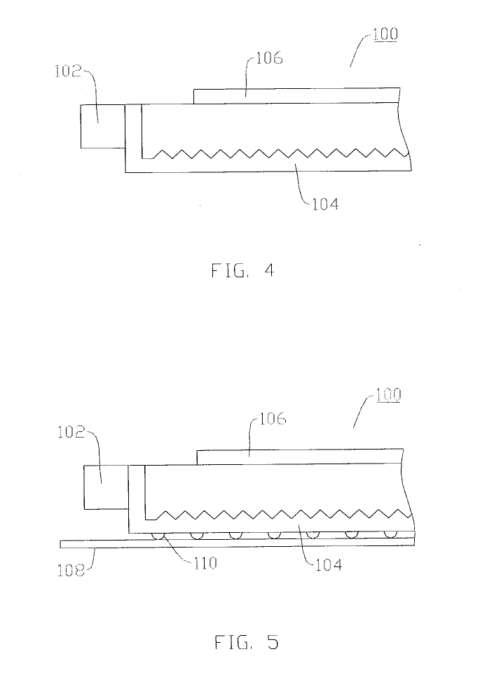

Next, a plane lighting structure is illustrated according to this invention. As shown in FIG. 3, a hollow wedge light guide plate 100 having the light-transmissive surface 104 with a plurality of reflecting slant portions (V-cut) can guide the light rays emitted from the light source 102 at the lateral side of the wedge light guide plate 100 toward the panel of the LCD monitor. The light source 102 can be a cold cathode fluorescent lamp or LED. When there are not any materials filled in the hollow portion of the light guide plate 100, the energy loss of the light rays is tiny because the light rays in the inner of the wedge light guide plate 100 only pass through the air. It can increase the brightness of the plane lighting module, decrease the power consumption and extend the life cycle of the light source 102 when the energy loss the light rays is reduced. And the weight of the whole plane lighting module is smaller because the inner of the wedge light guide plate 100 is hollow.

FIG. 4 is the cross-section view according to the further improvement on the embodiment of FIG. 3. The light source 102 is located at the lateral side of the hollow wedge light guide plate 100 having the light-transmissive surface 104 with a plurality of reflecting slant portions (V-cut). In this embodiment, the diffusion prism sheet 112 is put above the lens 106 of the LCD monitor to enhance the uniformity of the light rays. And a reflection surface can be affixed on the light-transmissive surface 104 in order to increase the brightness of the plane lighting structure.

FIG. 5 is another cross-section view according to the further improvement on the embodiment of FIG. 3. The reflection layer 108 can be placed on the bottom of the hollow wedge light guide plate 100 in order to increase the brightness of the plane lighting structure. The convex/concave dots can be set between the reflection layer 108 and the wedge light guide plate 100 in order the increase the light uniformity. These components can be implemented along with the embodiment of FIG. 4.

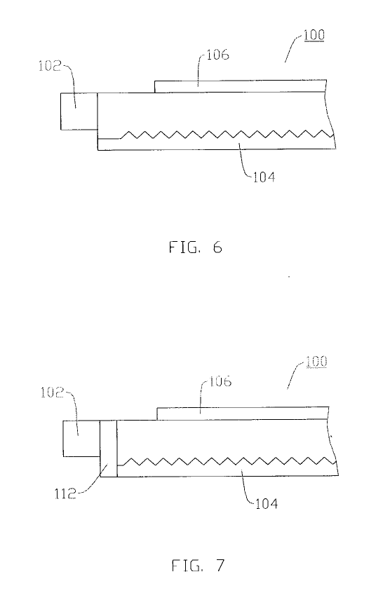

In above-mentioned embodiments, the substance between the hollow wedge light guide plate 100 and the light source 102 can be removed as shown in FIG. 6. Hence, the passing paths of the light rays in the wedge light guide plate 100 are almost without any media. Similarly, This method can be implemented along with the embodiments of FIG. 4 or FIG. 5. Besides, as shown in FIG. 7, the diffusion prism sheet 112 can be disposed at the lateral side of the light source 102 in order to improve the horizontal distribution of the light rays in the wedge light guide plate 100. It can also give stronger support to the wedge light guide plate 100 at the same time. The diffusion prism sheet 112 is helpful to solve for the darker problem of the both ends of the cold cathode fluorescent lamp. The diffusion prism sheet 112 is replaced with the convex/concave dots to solve the above problems.

However, the air is one of the media for the light distribution, which the light refraction index is about 1. Hence, other transparent materials can be filled into the hollow part of the wedge light guide plate 100 of the present invention if the light reflection indices of the filled material and the wedge light guide plate are different. The purpose of filled material is to provide the wedge light guide plate with a stronger support. But the density of the filled material must be small to reduce the weight of the wedge light guide plate and the energy loss of the light rays.

Although specific embodiments have been illustrated and described, it will be obvious to those skilled in the art that various modifications may be made without departing from what is intended to be limited solely by the appended claims.

What is claimed is:

1. A plane lighting structure, comprising:
a light source; and
a light guide plate having a light-transmissive surface that can guide the light rays emitted from said light source toward the direction which is about perpendicular to the connecting line from said light source to said light guide plate, wherein said light guide plate has two different materials and said light-transmissive surface is located between said two different materials.

2. The plane lighting structure according to claim 1, wherein said light-transmissive surface has a plurality of reflecting slant portions.

3. The plane lighting structure according to claim 2, wherein said light guide plate is a wedge light guide plate.

4. The plane lighting structure according to claim 3, wherein light refractive index of one of said two different materials is about 1.

5. The plane lighting structure according to claim 4 further comprising a reflection surface affixed on said light-transmissive surface to increase the brightness.

6. The plane lighting structure according to claim 3, wherein the light rays emitted from said light source pass through one of said two different materials in said wedge light guide plate.

7. The plane lighting structure according to claim 1 further comprising a reflection layer placed below the bottom of said light guide plate to increase the brightness.

8. The plane lighting structure according to claim 7 further comprising a plurality of convex and/or concave dots set between said reflection layer and said light guide plate.

9. The plane lighting structure according to claim 1, wherein said light source is selected from the group consisting of the cold cathode fluorescent lamp (CCFL) and LED.

10. A plane lighting structure, comprising:
a light source; and
a light guide plate having a light-transmissive surface that can guide the light rays emitted from said light source toward the direction which is about perpendicular to the connecting line from said light source to said light guide plate, wherein said light guide plate includes:
a first material; and
a second material which surrounds said first material, wherein said light-transmissive surface is located between said first and second materials and the light rays pass mainly through said first material.

11. The plane lighting structure according to claim 10, wherein light refractive index of said first material is about 1.

12. The plane lighting structure according to claim 11 further comprising a reflection surface affixed on said light-transmissive surface to increase the brightness.

13. The plane lighting structure according to claim 10, wherein said light guide plate is a wedge light guide plate.

14. The plane lighting structure according to claim 13 further comprising a reflection layer placed below the bottom of said wedge light guide plate to increase the brightness.

15. The plane lighting structure according to claim 14 further comprising a plurality of convex and/or concave dots set between said reflection layer and said wedge light guide plate.

16. The plane lighting structure according to claim 10, wherein said light source is selected from the group consisting of the cold cathode fluorescent lamp (CCFL) and LED.

17. A plane lighting structure, comprising:
a light source; and
a light guide plate having a light-transmissive surface that can guide the light rays emitted from said light source toward the direction which is about perpendicular to the connecting line from said light source to said light guide plate, wherein the light rays pass through the air except said light-transmissive surface in said light guide plate.

18. The plane lighting structure according to claim 17 further comprising a reflection surface affixed on said light-transmissive surface to increase the brightness.

19. The plane lighting structure according to claim 18, wherein said light guide plate is a wedge light guide plate.

20. The plane lighting structure according to claim 19 further comprising a reflection layer placed below the bottom of said wedge light guide plate to increase the brightness.

21. The plane lighting structure according to claim 20 further comprising a plurality of convex and/or concave dots set between said reflection layer and said wedge light guide plate.

22. The plane lighting structure according to claim 17, wherein said light source is selected from the group consisting of the cold cathode fluorescent lamp (CCFL) and LED.
